(19) United States
(12) Patent Application Publication
(10) Pub. No.: US 2026/0271978 A1
(43) Pub. Date: Sep. 17, 2026

(54) USE OF FATTY ACIDS TO MODIFY FLAVOR

(71) Applicant: Firmenich Incorporated, Plainsboro, NJ (US)

(72) Inventors: Joseph R. Fotsing, San Diego, CA (US); Anne-Claire Robineau, Satigny (CH); Nicolas Hanquet, Satigny (CH); Maryline Billat-Rossi, Satigny (CH)

(21) Appl. No.: 19/469,901

(22) PCT Filed: Mar. 19, 2024
(86) PCT No.: PCT/US2024/020489

§ 371 Date: Sep. 26, 2025

Related U.S. Application Data
(60) Provisional application No. 63/492,803, filed on Mar. 29, 2023.

(51) Int. Cl. A23L 27/20; A23C 11/10; A23J 3/14; A23J 3/22; A23L 27/00

(52) U.S. Cl. CPC A23L 27/2028; A23C 11/103; A23J 3/14; A23J 3/227; A23L 27/84; A23L 27/86; A23L 27/88

(57) ABSTRACT

The present disclosure generally relates to fatty acid compounds and their use to modify the flavor of ingestible compositions that contain non-animal proteins, such as vegan dairy analogues and vegan meat analogues. These flavor improvements include reducing a bitter taste, reducing an astringent taste, reducing a green vegetal taste, reducing a cereal taste, enhancing a sweet taste, enhancing mouthcoating, enhancing perceived thickness, enhancing mouthfeel, enhancing a creamy taste, or any combination thereof. In certain aspects, the disclosure provides ingestible compositions that include fatty acid compounds. In some embodiments, the ingestible compositions include a non-animal protein. In some embodiments, the ingestible composition comprises a high-intensity sweetener, such as a steviol glycoside sweetener. In certain aspects, the disclosure provides flavored products that include such ingestible compositions, such as a food, beverage, oral care, nutraceutical, or pharmaceutical products.

### TECHNICAL FIELD

The present disclosure generally relates to fatty acid compounds and their use to modify the flavor of ingestible compositions that contain non-animal proteins, such as vegan dairy analogues and vegan meat analogues. These flavor improvements include reducing a bitter taste, reducing an astringent taste, reducing a green vegetal taste, reducing a cereal taste, enhancing a sweet taste, enhancing mouthcoating, enhancing perceived thickness, enhancing mouthfeel, enhancing a creamy taste, or any combination thereof. In certain aspects, the disclosure provides ingestible compositions that include fatty acid compounds. In some embodiments, the ingestible compositions include a non-animal protein. In some embodiments, the ingestible composition comprises a high-intensity sweetener, such as a steviol glycoside sweetener. In certain aspects, the disclosure provides flavored products that include such ingestible compositions, such as a food, beverage, oral care, nutraceutical, or pharmaceutical products.

### DESCRIPTION OF RELATED ART

The taste system provides sensory information about the chemical composition of the external world. Taste transduction is one of the most sophisticated forms of chemical-triggered sensation in animals. Signaling of taste is found throughout the animal kingdom, from simple metazoans to the most complex of vertebrates. Mammals are believed to have five basic taste modalities: sweet, bitter, sour, salty, and umami.

Obesity, diabetes, and cardiovascular disease are major health concerns throughout the world and are growing at an alarming rate. Sugar and calories are key components that can be limited to rend er a positive nutritional effect on health. Even so, because a number of foods contain components that agonize bitter taste receptors, consumers often use sugar and other sweeteners to offset the perception of bitter taste in such foods. Further, certain nutritionally useful foods, such as vegetable proteins, agonize bitter taste receptors. Thus, despite their nutritional value, consumers may avoid such foods because of their perceived poor taste. Further, many medicinal compounds, such as antibiotics, have a distinctly bitter taste. Therefore, nutraceutical or pharmaceutical manufacturers must employ complicated formulation technologies to permit subjects to take such medicines orally without experiencing displeasure.

But the physiological basis concerning the perception of bitter taste and astringency is still not well understood. Some compounds are known to reduce certain bitter and astringent tastes. But many such compounds are complex organic compounds that may be expensive to make and are not typically found in nature. Thus, there is a continuing need to discover new compounds that can serve as effective blockers of certain bitter or astringent notes.

### SUMMARY

The present disclosure relates to the unexpected discovery that certain fatty acid compounds are effective, when used in combination with non-animal proteins, for improving the flavor of products containing such proteins, particularly vegan dairy analogue products.

In a first aspect, the disclosure provides uses of an unsaturated fatty acid compound for modifying a flavor of an ingestible composition, wherein the unsaturated fatty acid compound is a compound of formula (I) or a comestibly acceptable salt thereof:

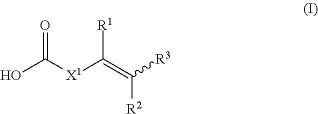

wherein:
   R¹ and R² are each independently a hydrogen atom or C₁₋₄ alkyl;
   R³ is a hydrogen atom, C₁₋₂₀ alkyl, or C₂₋₂₀ alkenyl; and
   X¹ is a direct bond or C₁₋₁₆ alkylene; and
wherein the ingestible composition comprises a non-animal protein, such as a plant protein, a mycoprotein, or an algal protein.

In a related aspect, the disclosure provides methods of modifying a flavor of an ingestible composition, the method comprising introducing an unsaturated fatty acid compound to the ingestible composition, wherein the unsaturated fatty acid compound is a compound of formula (I) or a comestibly acceptable salt thereof, which is set forth above, wherein the ingestible composition comprises a non-animal protein, such as a plant protein, a mycoprotein, or an algal protein.

In a second aspect, the disclosure provides uses of a saturated fatty acid compound for modifying a flavor of an ingestible composition, wherein the saturated fatty acid compound is a compound of formula (II) or a comestibly acceptable salt thereof:

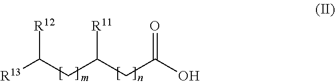

wherein:
   R¹¹, R¹², and R¹³ are each independently a hydrogen atom or C₁₋₄ alkyl;
   m is an integer ranging from 1 to 12; and
   n is an integer ranging from 0 to 12;
   wherein m+n is no more than 14; and
wherein the ingestible composition comprises a non-animal protein, such as a plant protein, a mycoprotein, or an algal protein

In a related aspect, the disclosure provides methods of modifying a flavor of an ingestible composition, the method comprising introducing a saturated fatty acid compound to the ingestible composition, wherein the saturated fatty acid compound is a compound of formula (II) or a comestibly acceptable salt thereof, which is set forth above, wherein the ingestible composition comprises a non-animal protein, such as a plant protein, a mycoprotein, or an algal protein.

In a third aspect, the disclosure provides an ingestible composition comprising: (a) a fatty acid compound, wherein the fatty acid compound is a compound of formula (I) or a comestibly acceptable salt thereof, as set forth above, or a saturated fatty acid compound of formula (II) or a comestibly acceptable salt thereof, as set forth above; and (b) a non-animal protein, such as a plant protein, a mycoprotein, or an algal protein.

In a fourth aspect, the disclosure provides a flavored product, which comprises an ingestible composition of the third aspect. In some embodiments, the flavored product is a food product, a beverage product, an oral care product, or a pharmaceutical or nutraceutical product. In some embodiments, the flavored product is a dairy analogue product, a meat analogue product, or a seafood analogue product.

Further aspects, and embodiments thereof, are set forth below in the Detailed Description, the Drawings, the Abstract, and the Claims.

### BRIEF DESCRIPTION OF THE DRAWINGS

The drawings are provided for illustrative purposes only and are not intended to describe any preferred compositions or preferred methods, or to serve as a source of any limitations on the scope of the claimed inventions.

FIG. 1 shows a chemical formulae representing two different classes of fatty acid compounds, wherein R¹ and R² are each independently a hydrogen atom or C₁₋₄ alkyl; R³ is a hydrogen atom. C₁₋₂₀ alkyl, or C₂₋₂₀ alkenyl; and X¹ is a direct bond or C₁₋₁₆ alkylene; and R¹¹, R¹², and R¹³ are each independently a hydrogen atom or C₁₋₄ alkyl; m is an integer ranging from 1 to 12; and n is an integer ranging from 0 to 12; wherein m+n is no more than 14.

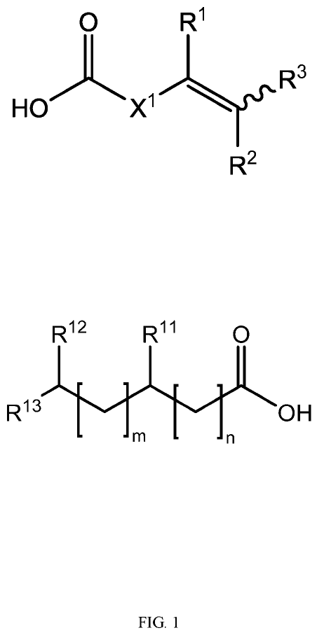

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

The term “unsaturated fatty acid compound” refers to a compound of formula (I) or any comestibly acceptable salts thereof.

The term “saturated fatty acid compound” refers to a compound of formula (II) or any comestibly acceptable salts thereof.

The term “fatty acid compound” refers to an unsaturated fatty acid compound (as defined above) or a saturated fatty acid compound (as defined above).

The terms a “sweetener” or a “sweet flavoring agent” or a “sweet flavor entity” or a “sweet compound” or a “sweet tastant” herein refers to a compound that elicits a detectable sweet flavor in a subject, e.g., a compound that activates a T1R2/T1R3 taste receptor in vitro.

The terms “bitter compound” or a “bitter tastant” herein refers to a compound that elicits a detectable bitter flavor in a subject, e.g., a compound that activates one or more T2R taste receptor in vitro. In many cases, such compounds elicit an astringent taste.

As used herein, “Cₐ to C_{b}” or “C_{a-b}” in which “a” and “b” are integers, refer to the number of carbon atoms in the specified group. That is, the group can contain from “a” to “b”, inclusive, carbon atoms. Thus, for example, a “C₁ to C₄ alkyl” or “C₁₋₄ alkyl” group refers to all alkyl groups having from 1 to 4 carbons, that is, —CH₃, —CH₂CH₃. —CH₂CH₂CH₃, —CH(CH₃)₂, —CH₂CH₂CH₂CH₃, —CH(CH₃)CH₂CH₃, and —C(CH₃)₃.

As used herein, “alkyl” means a straight or branched hydrocarbon chain that is fully saturated (i.e., contains no double or triple bonds). In some embodiments, an alkyl group has 1 to 20 carbon atoms (whenever it appears herein, a numerical range such as “1 to 20” refers to each integer in the given range: e.g., “1 to 20 carbon atoms” means that the alkyl group may consist of 1 carbon atom, 2 carbon atoms, 3 carbon atoms, etc., up to and including 20 carbon atoms, although the present definition also covers the occurrence of the term “alkyl” where no numerical range is designated). The alkyl group may also be a medium size alkyl having 1 to 9 carbon atoms. The alkyl group could also be a lower alkyl having 1 to 4 carbon atoms. The alkyl group may be designated as “C₁₋₄ alkyl” or similar designations. By way of example only, “C₁₋₄ alkyl” indicates that there are one to four carbon atoms in the alkyl chain, i.e., the alkyl chain is selected from the group consisting of methyl, ethyl, propyl, iso-propyl, n-butyl, iso-butyl, sec-butyl, and t-butyl. Typical alkyl groups include, but are in no way limited to, methyl, ethyl, propyl, isopropyl, butyl, isobutyl, tertiary butyl, pentyl, hexyl, and the like. Unless indicated to the contrary, the term “alkyl” refers to a group that is not further substituted. Note that the terms “butyl,” “pentyl,” “hexyl,” and the like refer to straight-chain moieties (and do not encompass branched-chain moieties), unless otherwise indicated to the contrary.

As used herein, “alkenyl” means a straight or branched hydrocarbon chain containing one or more double bonds. In some embodiments, the alkenyl group has from 2 to 20 carbon atoms, although the present definition also covers the occurrence of the term “alkenyl” where no numerical range is designated. The alkenyl group may also be a medium size alkenyl having 2 to 9 carbon atoms. The alkenyl group could also be a lower alkenyl having 2 to 4 carbon atoms. The alkenyl group may be designated as “C₂₋₄ alkenyl” or similar designations. By way of example only, “C₂₋₄ alkenyl” indicates that there are two to four carbon atoms in the alkenyl chain, i.e., the alkenyl chain is selected from the group consisting of ethenyl, propen-1-yl, propen-2-yl, propen-3-yl, buten-1-yl, buten-2-yl, buten-3-yl, buten-4-yl, 1-methyl-propen-1-yl, 2-methyl-propen-1-yl, 1-ethyl-ethen-1-yl, 2-methyl-propen-3-yl, buta-1,3-dienyl, buta-1,2,-dienyl, and buta-1,2-dien-4-yl. Typical alkenyl groups include, but are in no way limited to, ethenyl, propenyl, butenyl, pentenyl, and hexenyl, and the like. Unless indicated to the contrary, the term “alkenyl” refers to a group that is not further substituted.

As used herein, “alkylene” means a branched or straight chain fully saturated di-radical chemical group containing only carbon and hydrogen that is attached to the rest of the molecule via two points of attachment (i.e., an alkanediyl). In some embodiments, the alkylene group has from 1 to 20 carbon atoms, although the present definition also covers the occurrence of the term alkylene where no numerical range is designated. The alkylene group may also be a medium size alkylene having 1 to 9 carbon atoms. The alkylene group could also be a lower alkylene having 1 to 4 carbon atoms. The alkylene group may be designated as “C₁₋₄ alkylene” or similar designations. By way of example only, “C₁₋₄ alkylene” indicates that there are one to four carbon atoms in the alkylene chain, i.e., the alkylene chain is selected from the group consisting of methylene, ethylene, ethan-1,1-diyl, propylene, propan-1,1-diyl, propan-2,2-diyl, 1-methyl-ethylene, butylene, butan-1,1-diyl, butan-2,2-diyl, 2-methyl-propan-1,1-diyl, 1-methyl-propylene, 2-methyl-propylene, 1,1-dimethyl-ethylene, 1,2-dimethyl-ethylene, and 1-ethyl-ethylene. Unless indicated to the contrary, the term “alkylene” refers to a group that is not further substituted.

It is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, —CH₂CH(CH₃)CH₂—, and the like.

Wherever a substituent is depicted as a di-radical (i.e., has two points of attachment to the rest of the molecule), it is to be understood that the substituent can be attached in any directional configuration unless otherwise indicated. Thus, for example, a substituent depicted as -AE- or

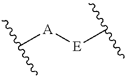

includes the substituent being oriented such that the A is attached at the leftmost attachment point of the molecule as well as the case in which A is attached at the rightmost attachment point of the molecule.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include.” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members. e.g., A₁ and A₂, then one or more members of the class can be present concurrently.

Other terms are defined in other portions of this description, even though not included in this subsection.

### Fatty Acid Compounds

The uses, methods, compositions, and products disclosed herein relate to fatty acid compounds, mainly in the context of ingestible compositions containing non-animal proteins.

In certain aspects, the fatty acid compound is an unsaturated fatty acid compound, namely, a compound of formula (I) or a comestibly acceptable salt thereof:

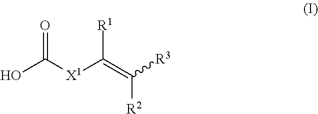

wherein:
   R¹ and R² are each independently a hydrogen atom or C₁₋₄ alkyl;
   R³ is a hydrogen atom, C₁₋₂₀ alkyl, or C₂₋₂₀ alkenyl; and
   X¹ is a direct bond or C₁₋₁₆ alkylene.

The variable R¹ can have any suitable value consistent with the definitions set forth above. In some embodiments. R¹ is a hydrogen atom. In some other embodiments, R¹ is C₁₋₄ alkyl, such as methyl, ethyl, propyl, isopropyl, and the like. In some embodiments, R¹ is methyl.

The variable R² can have any suitable value consistent with the definitions set forth above. In some embodiments. R² is a hydrogen atom. In some other embodiments, R² is C₁₋₄ alkyl, such as methyl, ethyl, propyl, isopropyl, and the like. In some embodiments, R² is methyl. In some embodiments, each of R¹ and R² is a hydrogen atom.

The variable R³ can have any suitable value consistent with the definitions set forth above. In some embodiments, R³ is a hydrogen atom. In some such embodiments, each of R² and R³ is a hydrogen atom.

In some other embodiments, R³ is C₁₋₂₀ alkyl. In some such embodiments, R³ is a straight-chain C₁₋₂₀ alkyl. In some further such embodiments, R³ is a straight-chain C₃₋₁₅ alkyl, such as propyl, butyl, pentyl, hexyl, heptyl, octyl, nonyl, decyl, undecyl, dodecyl, tridecyl, tetradecyl, or pentadecyl. In some other embodiments, R³ is C₁₋₄ alkyl, such as methyl, ethyl, propyl, isopropyl, and butyl. In some embodiments, R³ is methyl. In some embodiments, each of R² and R³ is C₁₋₄ alkyl. In some further such embodiments, each of R² and R³ is methyl.

In some other embodiments, R³ is C₂₋₂₀ alkenyl. In some further such embodiments, R³ is C₂₋₁₀ alkenyl. In some embodiments, such alkenyl groups contain a single carbon-carbon double bond, which can be in either an E or Z configuration. In some embodiments, the alkenyl group is a straight-chain alkenyl group. In other embodiments, the alkenyl group is a branched alkenyl group. In some embodiments, R³ is 4-methylpent-3-enyl.

X¹ can have any suitable value consistent with the definition set forth above. In some embodiments, X¹ is a direct bond, meaning that the carbon atom of the carbonyl group bonds directly with the carbon atom bearing the R¹ substituent. In some embodiments, X¹ is a direct bond, and R³ is a straight-chain C₃₋₁₅ alkyl, such as propyl, butyl, pentyl, hexyl, heptyl, octyl, nonyl, decyl, undecyl, dodecyl, tridecyl, tetradecyl, or pentadecyl. In some embodiments, X¹ is a direct bond, and R³ is C₂₋₁₀ alkenyl.

In some other embodiments, X¹ is C₁₋₁₆ alkylene. In some such embodiments, X¹ is a branched C₂₋₁₆ alkylene, such as 2-methyl-1,4-butandiyl. In some such embodiments, X¹ is a straight-chain C₁₋₁₆ alkylene, such as a moiety of the formula —(CH₂)ₓ—, wherein x is 1, 2, 3, 4, 5, 6, 7, 8, 9, 10, 11, 12, 13, 14, 15, or 16. In some embodiments, X¹ is not a direct bond (namely, X¹ is a C₁₋₁₆ alkylene group according to any of the embodiments set forth in this paragraph), and each of R² and R³ is a hydrogen atom.

Table 1 below sets forth various examples of fatty acid compounds according to certain embodiments. Each compound is itself a separate embodiment of a fatty acid compound.

TABLE 1

| No. | Structure |
|---|---|
| 101 | 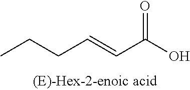 |
| 102 | 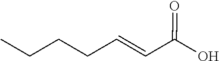 |
| | (E)-Hept-2-enoic acid |
| 103 | 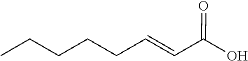 |
| | (E)-Oct-2-enoic acid |
| 104 | 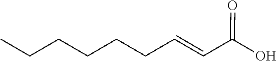 |
| | (E)-Non-2-enoic acid |
| 105 | 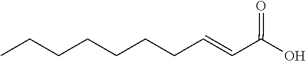 |
| | (E)-Dec-2-enoic acid |
| 106 | 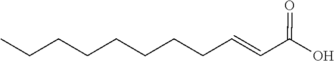 |
| | (E)-Undec-2-enoic acid |
| 107 | 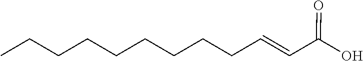 |
| | (E)-Dodec-2-enoic acid |
| 108 | 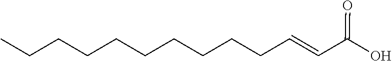 |
| | (E)-Tridec-2-enoic acid |
| 109 | 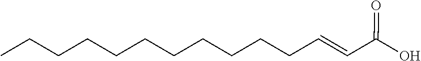 [SMILES: CCCCCCCCCCC/C=C/C(=O)O] |
| | (E)-Tetradec-2-enoic acid |
| 110 | 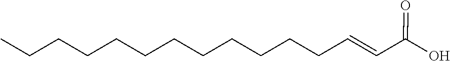 [SMILES: CCCCCCCCCCCC/C=C/C(=O)O] |
| | (E)-Pentadec-2-enoic acid |
| 111 | 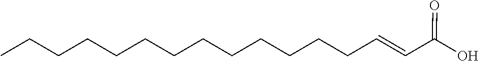 [SMILES: CCCCCCCCCCCCC/C=C/C(=O)O] |
| | (E)-Hexadec-2-enoic acid |
| 112 | 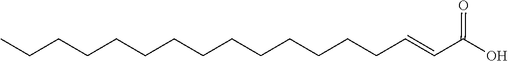 [SMILES: CCCCCCCCCCCCCC/C=C/C(=O)O] |
| | (E)-Heptadec-2-enoic acid |
| 113 | 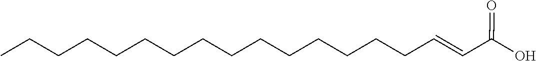 [SMILES: CCCCCCCCCCCCCCC/C=C/C(=O)O] |
| | (E)-Octadec-2-enoic acid |
| 114 | 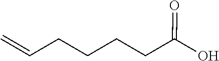 |
| | Hept-6-enoic acid |
| 115 | 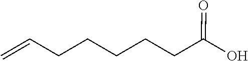 |
| | Oct-7-enoic acid |
| 116 | 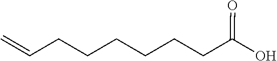 |
| | Non-8-enoic acid |
| 117 | 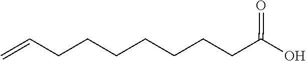 |
| | Dec-9-enoic acid |
| 118 | 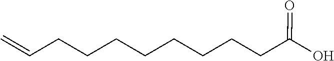 |
| | Undec-10-enoic acid |
| 119 | 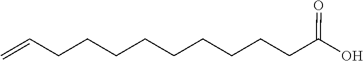 |
| | Dodec-11-enoic acid |
| 120 | 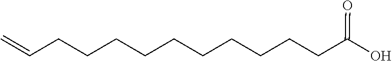 |
| | Tridec-12-enoic acid |
| 121 | 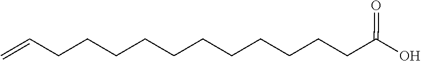 [SMILES: C=CCCCCCCCCCCCC(=O)O] |
| | Tetradec-13-enoic acid |
| 122 | 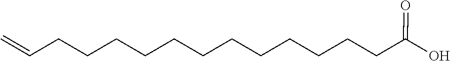 [SMILES: C=CCCCCCCCCCCCCC(=O)O] |
| | Pentadec-14-enoic acid |
| 123 | 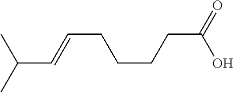 |
| | (E)-8-methylnon-6-enoic acid |
| 124 | 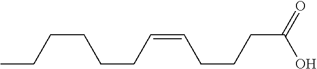 |
| | (Z)-Dodec-5-enoic acid |
| 125 | 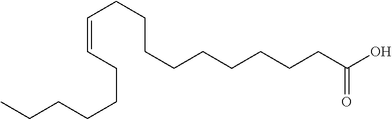 [SMILES: CCCCCC/C=C\CCCCCCCCCC(=O)O] |
| | (Z)-Octadec-11-enoic acid |
| 126 | 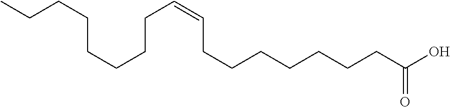 [SMILES: CCCCCCCC/C=C\CCCCCCCC(=O)O] |
| | Oleic acid |
| 127 | 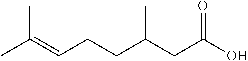 |
| | 3,7-dimethyloct-6-enoic acid |
| 128 | 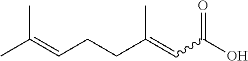 |
| | (E/Z)-3,7-dimethylocta-2,6-dienoic acid |
| 129 | 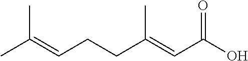 |
| | (E)-3,7-dimethylocta-2,6-dienoic acid |
| 130 | 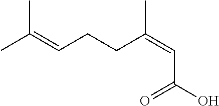 |
| | (Z)-3,7-dimethylocta-2,6-dienoic acid |

In some embodiments, the fatty acid compound is any one of the compounds set forth in Table 1. In some embodiments, the fatty acid compound is Compound 101. In some embodiments, the fatty acid compound is Compound 102. In some embodiments, the fatty acid compound is Compound 103. In some embodiments, the fatty acid compound is Compound 104. In some embodiments, the fatty acid compound is Compound 105. In some embodiments, the fatty acid compound is Compound 106. In some embodiments, the fatty acid compound is Compound 107. In some embodiments, the fatty acid compound is Compound 108. In some embodiments, the fatty acid compound is Compound 109. In some embodiments, the fatty acid compound is Compound 110. In some embodiments, the fatty acid compound is Compound 111. In some embodiments, the fatty acid compound is Compound 112. In some embodiments, the fatty acid compound is Compound 113. In some embodiments, the fatty acid compound is Compound 114. In some embodiments, the fatty acid compound is Compound 115. In some embodiments, the fatty acid compound is Compound 116. In some embodiments, the fatty acid compound is Compound 117. In some embodiments, the fatty acid compound is Compound 118. In some embodiments, the fatty acid compound is Compound 119. In some embodiments, the fatty acid compound is Compound 120. In some embodiments, the fatty acid compound is Compound 121. In some embodiments, the fatty acid compound is Compound 122. In some embodiments, the fatty acid compound is Compound 123. In some embodiments, the fatty acid compound is Compound 124. In some embodiments, the fatty acid compound is Compound 125. In some embodiments, the fatty acid compound is Compound 126. In some embodiments, the fatty acid compound is Compound 127. In some embodiments, the fatty acid compound is Compound 128. In some embodiments, the fatty acid compound is Compound 129. In some embodiments, the fatty acid compound is Compound 130.

In certain aspects, the fatty acid compound is a saturated fatty acid compound, namely, a compound of formula (II) or a comestibly acceptable salt thereof:

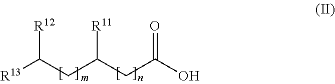

wherein:
   R¹¹, R¹², and R¹³ are each independently a hydrogen atom or C₁₋₄ alkyl;
   m is an integer ranging from 1 to 12; and
   n is an integer ranging from 0 to 12; and
   wherein m+n is no more than 14.

The variable R¹¹ can have any suitable value consistent with the definitions set forth above. In some embodiments, R¹¹ is a hydrogen atom. In some other embodiments, R¹¹ is C₁₋₄ alkyl, such as methyl, ethyl, propyl, isopropyl, and the like. In some embodiments, R¹¹ is methyl. In some embodiments, R¹¹ is ethyl.

The variable R¹² can have any suitable value consistent with the definitions set forth above. In some embodiments. R¹² is a hydrogen atom. In some other embodiments. R¹² is C₁₋₄ alkyl, such as methyl, ethyl, propyl, isopropyl, and the like. In some embodiments, R¹² is methyl. In some embodiments, each of R¹¹ and R¹² is a hydrogen atom. In some embodiments, each of R¹¹ and R¹² is methyl.

The variable R¹³ can have any suitable value consistent with the definitions set forth above. In some embodiments, R¹³ is a hydrogen atom. In some such embodiments, each of R¹² and R¹³ is a hydrogen atom. In some other embodiments, R¹³ is C₁₋₄ alkyl, such as methyl, ethyl, propyl, isopropyl, and the like. In some embodiments, R¹³ is methyl. In some embodiments, each of R¹² and R¹³ is methyl.

The variables m and n can have any suitable value consistent with the definition set forth above. In some embodiments, m is an integer ranging from 1 to 11, or from 1 to 10, or from 1 to 9, or from 1 to 8, or from 1 to 7, or from 1 to 6, or from 1 to 5, or from 1 to 4, or from 1 to 3. In some embodiments, m is 1 or 2. In some embodiments, n is an integer ranging from 0 to 11, or from 0 to 10, or from 0 to 9, or from 0 to 8, or from 0 to 7, or from 0 to 6, or from 0 to 5, or from 0 to 4, or from 0 to 3, or from 0 to 2. In some embodiments, n is 0 or 1. In some embodiments, n is 0. In some embodiments, n is 1. In some further embodiments, the sum of m and n is an integer ranging from 1 to 16, or from 1 to 15, or from 1 to 14, or from 1 to 13, or from 1 to 12, or from 1 to 11, or from 1 to 10, or from 1 to 9, or from 1 to 8, or from 1 to 7, or from 1 to 6.

Table 2 below sets forth various examples of fatty acid compounds according to certain embodiments. Each compound is itself a separate embodiment of a fatty acid compound.

TABLE 2

| No. | Structure |
|---|---|
| 201 | 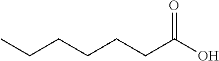 |
| | Heptanoic acid (Enanthic acid) |
| 202 | 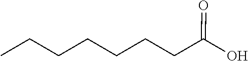 |
| | Octanoic acid (Caprylic acid) |
| 203 | 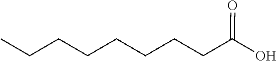 |
| | Nonanoic acid (Pelargonic acid) |
| 204 | 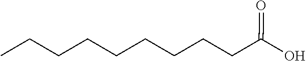 |
| | Decanoic acid (Capric acid) |
| 205 | 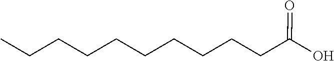 |
| | Undecanoic acid |
| 206 | 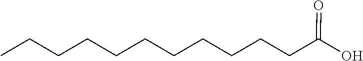 |
| | Dodecanoic acid (Lauric acid) |
| 207 | 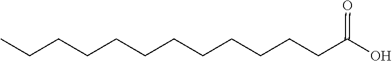 |
| | Tridecanoic acid |
| 208 | 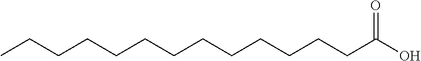 [SMILES: CCCCCCCCCCCCCC(=O)O] |
| | Tetradecanoic acid (Myristic acid) |
| 209 | 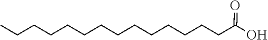 [SMILES: CCCCCCCCCCCCCCC(=O)O] |
| | Pentadecanoic acid |
| 210 | 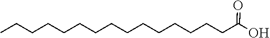 [SMILES: CCCCCCCCCCCCCCCC(=O)O] |
| | Hexadecanoic acid (Palmitic acid) |
| 211 | 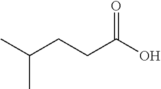 |
| | 4-Methylpentanoic acid |
| 212 | 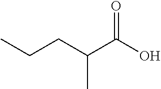 |
| | 2-Methylpentanoic acid |
| 213 | 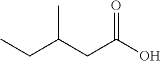 |
| | 3-Methylpentanoic acid |
| 214 | 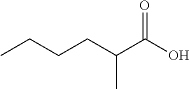 |
| | 2-Methylhexanoic acid |
| 215 | 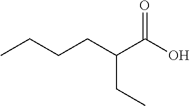 |
| | 2-Ethylhexanoic acid |
| 216 | 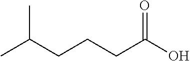 |
| | 5-Methylhexanoic acid |
| 217 | 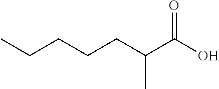 |
| | 2-Methylheptanoic acid |
| 218 | 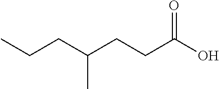 |
| | 4-Methylheptanoic acid |
| 219 | 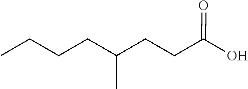 |
| | 4-Methyloctanoic acid |
| 220 | 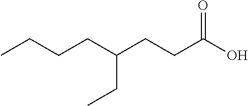 |
| | 4-Ethyloctanoic acid |
| 221 | 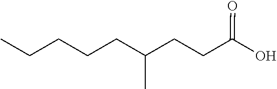 |
| | 4-Methylnonanoic acid |

In some embodiments, the fatty acid compound is any one of the compounds set forth in Table 2. In some embodiments, the fatty acid compound is Compound 201. In some embodiments, the fatty acid compound is Compound 202. In some embodiments, the fatty acid compound is Compound 203. In some embodiments, the fatty acid compound is Compound 204. In some embodiments, the fatty acid compound is Compound 205. In some embodiments, the fatty acid compound is Compound 206. In some embodiments, the fatty acid compound is Compound 207. In some embodiments, the fatty acid compound is Compound 208. In some embodiments, the fatty acid compound is Compound 209. In some embodiments, the fatty acid compound is Compound 210. In some embodiments, the fatty acid compound is Compound 211. In some embodiments, the fatty acid compound is Compound 112. In some embodiments, the fatty acid compound is Compound 213. In some embodiments, the fatty acid compound is Compound 214. In some embodiments, the fatty acid compound is Compound 215. In some embodiments, the fatty acid compound is Compound 216. In some embodiments, the fatty acid compound is Compound 217. In some embodiments, the fatty acid compound is Compound 218. In some embodiments, the fatty acid compound is Compound 219. In some embodiments, the fatty acid compound is Compound 220. In some embodiments, the fatty acid compound is Compound 221.

Isotopes may be present in any of the fatty acid compounds described. Each chemical element as represented in a compound structure may include any isotope of said element. For example, in a compound structure a hydrogen atom may be explicitly disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

In some embodiments, the fatty acid compounds capable of forming acid or base salts by virtue of the presence of amino or carboxyl groups or groups similar thereto. Comestibly acceptable acid addition salts can be formed with inorganic acids and organic acids. Inorganic acids from which salts can be derived include, for example, hydrochloric acid, hydrobromic acid, sulfuric acid, nitric acid, phosphoric acid, and the like. Organic acids from which salts can be derived include, for example, acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid, and the like. Comestibly acceptable salts can be formed using inorganic and organic bases. Inorganic bases from which salts can be derived include, for example, bases that contain sodium, potassium, lithium, ammonium, calcium, magnesium, iron, zinc, copper, manganese, aluminum, and the like; particularly preferred are the ammonium, potassium, sodium, calcium and magnesium salts. In some embodiments, treatment of the fatty acid compounds disclosed herein with an inorganic base results in loss of a labile hydrogen from the compound to afford the salt form including an inorganic cation such as Li⁺, Na⁺, K⁺, Mg²⁺ and Ca²⁺ and the like. Organic bases from which salts can be derived include, for example, primary, secondary, and tertiary amines, substituted amines including naturally occurring substituted amines, cyclic amines, basic ion exchange resins, and the like, specifically such as isopropylamine, trimethylamine, diethylamine, triethylamine, tripropylamine, and ethanolamine. In some embodiments, the salts are comestibly acceptable salts, which are salts suitable for inclusion in ingestible compositions, such as food or beverage products.

In some embodiments, the fatty acid compound is in its free (non-salt) form. In other embodiments, the fatty acid compound is a comestibly acceptable salt of any of the compounds set forth above.

In some embodiments, the fatty acid compounds exist as a crystalline solid, either in substantially pure form or in a formulation such as those set forth below. The crystalline solid can have any suitable polymorphic form, such as any polymorphic form obtainable via recrystallization in any suitable solvent system, according to techniques commonly used in the art of polymorph screening.

In some other embodiments, the fatty acid compounds exist as an amorphous solid or a semi-amorphous solid, meaning that it lacks any regular crystalline structure. Such solids can be generated using standard techniques, such as spray drying, and the like.

In some embodiments, the fatty acid compounds exist as a solvate, which is a pseudomorphic form of the compound in which one or more solvent molecules (such as water molecules) are taken up into the crystalline structure. Any suitable solvent or combination of solvents can be used, including, but not limited to, water, methanol, ethanol, n-propanol, isopropanol, n-butanol, 2-butanol, isobutanol, ethyl acetate, ethylene glycol, 1,2-propylene glycol, 1,3-propylene glycol, and the like. In some embodiments, the disclosure provides hydrates of the fatty acid compounds. Such solvates can be generated by any suitable means, such as those techniques typically used by skilled artisans in the field of polymorph and solvate screening.

In some other embodiments, the fatty acid compounds exist as a co-crystal with one or more other compounds, such as one or more other sweetener compounds. The fatty acid compounds can form a co-crystal with any suitable compound. Non-limiting examples of such suitable compounds include fructose, glucose, galactose, sucrose, lactose, maltose, allulose, sugar alcohols (such as erythritol, sorbitol, xylitol, and the like), sucralose, steviol glycosides (such as rebaudioside A, rebaudioside B, rebaudioside D, rebaudioside E, rebaudioside M, and the like natural stevioside compounds), other mogrosides (such as mogroside V, isomogroside V, siamenoside I, isomogroside III_{E}, the 1,6-α isomer of siamenoside I, and the like), aspartame, saccharin, acesulfame K, cyclamate, inulin, isomalt, and maltitol. Such co-crystals can be generated by any suitable means, such as those set forth in U.S. Patent Application Publication No. 2018/0363074, which is incorporated herein by reference.

In some embodiments, the fatty acid compounds are in the form of a dry particle. Such dry particles can be formed by standard techniques in the art, such as dry granulation, wet granulation, and the like. Such particles can also contain a number of excipients, including, inert diluents, such as calcium carbonate, sodium carbonate, lactose, calcium phosphate, and sodium phosphate; granulating and disintegrating agents, such as starch, cellulosic materials, and alginic acid; binding agents, such as gelatin, guar gum, and acacia; and lubricating agents, such as magnesium stearate, stearic acid, and talc. Other excipients typically used in food and beverage products can also be included, such as typical foodstuff materials.

In some embodiments, the fatty acid compounds are in the form of a liquid solution or a liquid suspension. Such compositions can also include: carboxymethylcellulose, methylcellulose, hydroxypropvlmethylcellulose, sodium alginate, polyvinylpyrrolidone, gum tragacanth and gum acacia; dispersing or wetting agents may be a naturally-occurring phosphatide such as lecithin, or condensation products of an alkylene oxide with fatty acids, for example polyoxyethylene stearate, or condensation products of ethylene oxide with long chain aliphatic alcohols, for example, heptadecaethyl-eneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. Such compositions can also include one or more coloring agents, one or more flavoring agents, and the like. Such liquid suspensions and solutions have a liquid carrier. In general, the liquid carrier comprises water. In some such cases, the liquid composition is an emulsion, such as an oil-in-water or a water-in-oil emulsion. Further, in some cases, water may be too polar to dissolve the fatty acid compounds to the desired concentration. In such instances, it can be desirable to introduce water-miscible solvents, such as alcohols, glycols, polyols, and the like, to the solvent to enhance solubilization of the fatty acid compounds.

In some embodiments, the fatty acid compounds are in the form of a solution, i.e., are solvated within a liquid carrier. In some embodiments, the liquid carrier is an aqueous carrier. Such solutions can be diluted to any suitable concentration.

### Uses and Methods

In certain aspects, the disclosure provides use of a fatty acid compound for modifying a flavor of an ingestible composition. In some embodiments, use for modifying a flavor comprises a use for reducing a bitter taste, a use for reducing an astringent taste, or a use for reducing green vegetal taste (for example, from plant proteins), reducing a cereal note (for example, from certain plant proteins), enhancing a sweet taste, enhancing a creamy taste, enhancing mouthcoating, enhancing a mouthfeel, enhancing perceived thickness, or any combinations thereof. In some embodiments, the use for modifying a flavor is a use for reducing a bitter taste. In some embodiments, the use for modifying a flavor is a use for reducing an astringent taste. In some embodiments, the use for modifying a flavor is a use for reducing green vegetal taste (for example, from plant proteins). In some embodiments, the use for modifying a flavor is a use for reducing a cereal note (for example, from certain plant proteins). In some embodiments, the use for modifying a flavor is a use for enhancing a sweet taste. In some embodiments, the use for modifying a flavor is a use for enhancing a creamy taste. In some embodiments, the use for modifying a flavor is a use for enhancing mouthcoating. In some embodiments, the use for modifying a flavor is a use for enhancing perceived thickness. In some embodiments, the use for modifying a flavor is a use for enhancing a mouthfeel. In some embodiments, the ingestible composition comprises a non-animal protein, such as a plant protein, a mycoprotein, a algal protein, or any combination thereof. In some embodiments, the ingestible composition comprises a plant protein.

In a related aspect, the disclosure provides methods of modifying a flavor of an ingestible composition, the method comprising introducing a fatty acid compound to the ingestible composition. In some embodiments, modifying a flavor is reducing a bitter taste, a reducing an astringent taste, reducing a green vegetal taste (for example, from plant proteins), reducing a cereal note (for example, from certain plant proteins), enhancing a sweet taste, enhancing a creamy taste, enhancing mouthcoating, enhancing a mouthfeel, enhancing perceived thickness, or any combinations thereof. In some embodiments, the use for modifying a flavor is a use for reducing a bitter taste. In some embodiments, modifying a flavor is reducing an astringent taste. In some embodiments, modifying a flavor is reducing green vegetal taste (for example, from plant proteins). In some embodiments, modifying a flavor is reducing a cereal note (for example, from certain plant proteins). In some embodiments, modifying a flavor is enhancing a sweet taste. In some embodiments, modifying a flavor is enhancing a creamy taste. In some embodiments, modifying a flavor is enhancing mouthcoating. In some embodiments, modifying a flavor is enhancing perceived thickness. In some embodiments, modifying a flavor is enhancing a mouthfeel. In some embodiments, the ingestible composition comprises a non-animal protein, such as a plant protein, a mycoprotein, a algal protein, or any combination thereof. In some embodiments, the ingestible composition comprises a plant protein.

In some embodiments, the non-animal protein is a plant protein, an algal protein, or any combination thereof. In some embodiments, the non-animal protein is a plant protein. Any suitable plant protein can be used. Some non-limiting examples of such plant proteins are pea protein, soy protein, almond protein, cashew protein, canola (rapeseed) protein, chickpea protein, fava bean protein, sunflower protein, mung bean protein, red lentil protein, wheat protein, oat protein, potato protein, and any combinations thereof. In some embodiments, the plant protein is pea protein, soy protein, or a combination thereof. In some other embodiments, the non-animal protein is an algal protein, such as a protein of a microalgae (such as spirulina or chlorella) or a macroalgae (such as seaweed). In some embodiments, the non-animal protein is comprised by seaweed flour. In some embodiments, the non-animal protein is pea protein, oat protein, chickpea protein, mung bean protein, or any combination thereof.

The ingestible composition can include plant or algal proteins at any suitable concentration. In some embodiments, the ingestible composition comprises plant protein at a concentration ranging from 0.1 weight percent to 15 weight percent, or from 0.5 weight percent to 12 weight percent, or from 1 weight percent to 10 weight percent, based on the total dry weight of the ingestible composition.

Any suitable concentration of a fatty acid compound can be used in or introduced to the ingestible composition. In some embodiments, the fatty acid compound is used in or introduced to the ingestible composition at a concentration ranging from 10 ppm to 10000 ppm, or from 50 ppm to 5000 ppm, or from 100 ppm to 2000 ppm, or from 100 ppm to 1500 ppm, or from 200 ppm to 1200 ppm, or from 400 ppm to 1000 ppm, based on the total weight of the ingestible composition.

Further embodiments concerning the ingestible compositions are set forth in the section below, any of which may be combined with the embodiments set forth in this section.

### Ingestible Compositions

In certain aspects, the disclosure provides an ingestible composition comprising fatty acid compound and one or more other bitter or astringent tastants, such as caffeine, tannins, compounds from coffee, compounds from ginseng, animal proteins, such as whey protein or casein, citrus fruit or juices, and high-intensity sweeteners, such as saccharin, steviol glycosides, aspartame, neotame, acesulfame potassium, mogrosides, and the like.

In some embodiments, the bitter or astringent tastant is a steviol glycoside compound, such as a stevia extract or compounds such as stevioside, rebaudioside A, rebaudioside D, rebaudioside E, rebaudioside M. or any combination thereof. The ingestible composition can include steviol glycosides at any suitable concentration. In some embodiments, the ingestible composition comprises steviol glycosides at a concentration ranging from 1 ppm to 5000 ppm, or from 5 ppm to 1000 ppm, or from 50 ppm to 1000 ppm, or from 100 ppm to 500 ppm, based on the total weight of the ingestible composition.

The ingestible compositions disclosed herein, including those referenced in various uses and methods, can include any number of other ingredients. Further such embodiments are set forth in greater detail below.

In certain particular embodiments, the ingestible composition comprises sodium (i.e., sodium cation, which can be replaced by potassium cation). In some such embodiments, the introduction of the fatty acid compound permits one to use less sodium (such as more than 10% less, more than 20% less, more than 30% less, more than 40% less, more than 50% less, more than 60% less, or more than 70% less, or more than 80% less, or more than 90% less) and still achieve a taste characteristic of a comparable product that employs a higher concentration of sodium. In some related embodiments, the use of the fatty acid compound permits the elimination of sodium from the composition. Such ingestible compositions can be in any suitable form. In some embodiments, the ingestible composition is a food product, such as any of those specifically listed below. In other embodiments, the ingestible composition is a beverage product, such as a soda, and the like. The sodium can be any suitable sodium source, such as table salt, sea salt, soy sauce, fish sauce, shrimp paste, butter, miso, and Worcestershire sauce.

In some instances, one may be able to reduce the amount of sugar in a product by reducing bitter taste or astringency. In some such embodiments, the introduction of the fatty acid compound permits one to use less sugar (such as more than 10% less, more than 20% less, more than 30% less, more than 40% less, more than 50% less, more than 60% less, or more than 70% less) and still achieve a taste characteristic of a comparable product that employs more sugar. The sugar can be any suitable sugar or combination of sugars, including, without limitation, sucrose, fructose (for example, high-fructose corn syrup), glucose, allulose, or any combinations thereof. In some embodiments, the ingestible composition is a food product, such as any of those specifically listed below. In other embodiments, the ingestible composition is a beverage product, such as a soda, and the like.

In some instances, one may be able to reduce the amount of a non-sugar sweetener in a product by reducing bitter taste or astringency. In some such embodiments, the introduction of the fatty acid compound permits one to use less non-sugar sweetener (such as more than 10% less, more than 20% less, more than 30% less, more than 40% less, more than 50% less, more than 60% less, or more than 70% less) and still achieve a taste characteristic of a comparable product that employs more non-sugar sweetener. The non-sugar sweetener can be any suitable sugar or combination of sugars, including, without limitation, sucralose, rebaudiosides (such as rebaudioside A, rebaudioside D, rebaudioside E, rebaudioside M, or any combination thereof), acesulfame potassium, sugar alcohols (such as erythritol), aspartame, neotame, cyclamate, mogrosides (such as mogroside III, mogroside IV, mogroside V, siamenoside I, isomogroside V, mogroside IVE, isomogroside IV, isomogroside IVE, mogroside IIIE, 11-oxomogroside V, the 1,6-alpha isomer of siamenoside I, or any combinations thereof), or any combinations thereof. In some embodiments, the ingestible composition is a food product, such as any of those specifically listed below. In other embodiments, the ingestible composition is a beverage product, such as a soda, and the like. In some such embodiments, the non-sugar sweetener is a rebaudioside.

In certain embodiments of any aspects and embodiments set forth herein that refer to an ingestible composition, the ingestible composition is a non-naturally occurring product, such as a composition specifically manufactured for the production of a flavored product, such as food or beverage product.

In some embodiments, the ingestible composition comprises a sweetener. The sweetener can be present in the ingestible composition in any suitable concentration. For example, in some embodiments, the sweetener is present in an amount from about 0.1% to about 12% by weight. In some embodiments, the sweetener is present in an amount from about 0.2% to about 10% by weight. In some embodiments, the sweetener is present in an amount from about 0.3% to about 8% by weight. In some embodiments, the sweetener is present in an amount from about 0.4% to about 6% by weight. In some embodiments, the sweetener is present in an amount from about 0.5% to about 5% by weight. In some embodiments, the sweetener is present in an amount from about 1% to about 2% by weight. In some embodiments, the sweetener is present in an amount from about 0.1% to about 5% by weight. In some embodiments, the sweetener is present in an amount from about 0.1% to about 4% by weight. In some embodiments, the sweetener is present in an amount from about 0.1% to about 3% by weight. In some embodiments, the sweetener is present in an amount from about 0.10% to about 2% by weight. In some embodiments, the sweetener is present in an amount from about 0.1% to about 1% by weight. In some embodiments, the sweetener is present in an amount from about 0.1% to about 0.5% by weight. In some embodiments, the sweetener is present in an amount from about 0.5% to about 10% by weight. In some embodiments, the sweetener is present in an amount from about 2% to about 8% by weight. In some further embodiments of the embodiments set forth in this paragraph, the sweetener is sucrose, fructose, glucose, xylitol, erythritol, or combinations thereof.

In some other embodiments, lower concentrations of sweetener may be more appropriate. For example, in some embodiments, the sweetener is present in an amount from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the sweetener is a steviol glycoside, a mogroside, a derivative of either of the foregoing, such as glycoside derivatives (e.g., glucosylates), or any combination thereof.

The compositions can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The sweetener can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula popufolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bemadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the sweeteners mentioned above. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the ingestible compositions are free (or, in some embodiments) substantially free of stevia-derived sweeteners, such as steviol glycosides, glucosylated steviol glycosides, or rebaudiosides.

The ingestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The ingestible compositions can have any suitable pH. In some embodiments, the flavor-modifying compounds enhance the sweetness of a sweetener under a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7. In certain embodiments, compounds as disclosed and described herein, individually or in combination, can enhance the perceived sweetness of a fixed concentration of a sweetener in taste tests at a compound concentration of 50 μM, 40 μM, 30 μM, 20 μM, or 10 μM at both low to neutral pH value. In certain embodiments, the enhancement factor of the compounds as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

In some embodiments, ingestible compositions disclosed herein comprise the fatty acid compound combined with one or more umami or kokumi tastants. Such umami or kokumi tastants include, but are not limited to, N-(heptan-4-yl)-benzo[d][1,3]dioxole-5-carboxamide, N¹-(2,4-dimethoxybenzyl)-N²-(2-(pyridin-2-yl)ethyl)oxalamide, alkyl amides, glutamates (such as monosodium glutamate (MSG)), arginates, purinic ribotides (such as inosine monophosphate (IMP), adenosine monophosphate (AMP), guanosine monophosphate (GMP), and sodium salts thereof), amino acids (such as L-threanine), oligopeptides (such as glutamyl oligopeptides), cheeses and cheese extracts, yeast extracts, and alcohol. The fatty acid compound may be used in combination with such umami or kokumi tastants in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1.4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some embodiments, ingestible compositions disclosed herein comprise the fatty acid compound combined with one or more bitter or astringent tastants. Such bitter or astringent tastants include, but are not limited to, active pharmaceutical ingredients (APIs), tannins (such as those in coffee, tea, or wine), ginseng, vitamins, minerals, limonin or nomelin (such as found in citrus juices), caffeine, quinine, catechins, polyphenols, potassium chloride, menthol, other commonly used oral care ingredients, cooling agents (such as N-ethyl-N-(thiophen-2-ylmethyl)-2-(p-tolyloxy)acetamide, N-(1H-pyrazol-3-yl)-N-(thiophen-2-ylmethyl)-2-(p-tolyloxy)acetamide, 2-(4-fluorophenoxy)-N-(1H-pyrazol-3-yl)-N-(thiophen-2-ylmethyl)acetamide, 2-(2-hydroxy-4-methylphenoxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, and 2-((5-methoxybenzofuran-2-yl)oxy)-N-(1H-pyrazol-3-yl)-N-(thiophen-2-ylmethyl)-acetamide), plant starches or proteins (such as pea protein, soy protein, chickpea protein, bean protein, or potato protein), algal proteins or starches, fungal proteins or starches, or alcohol, high-intensity sweeteners, such as saccharin, steviol glycosides, mogrosides, aspartame, and the like. In some embodiments, the bitter or astringent tastant is a plant protein. In some other embodiments, the bitter or astringent tastant is a steviol glycoside compound, such as stevioside, rebaudioside A, rebaudioside D, rebaudioside E, rebaudioside M, or any combination thereof. The fatty acid compound may be used in combination with such bitter or astringent tastants in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

The ingestible compositions set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness or licorice taste, compounds that enhance saltiness, compounds that enhance a cooling effect, or any combinations of the foregoing.

Thus, in some embodiments, ingestible compositions disclosed herein comprise the fatty acid compound and one or more sweetness enhancing compounds. Such sweetness enhancing compounds include, but are not limited to, 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]thiadiazin-5-yl)oxy)-2-methyl-propan-2-yl)isonicotinamide, 4-amino-5,6-dimethylthieno[2,3-d]pyrimidin-2(1H)-one, hesperitin dihydrochalcone, hesperitin dihydrochalcone-4′-O′glucoside, neohesperitin dihydrochalcone, naringenin, naringin, phloretin, glucosylated steviol glycosides, trilobatin, eriodictyol, homoeriodictyol, brazzein. (2R,3R)-3-acetoxy-5,7,4′-trihydroxyflavanone, (2R,3R)-3-acetoxy-5,7,3′-trihydroxy-4′-methoxyflavanone, rubusosides, or compounds such as those set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. In some embodiments, the ingestible composition comprises phloretin, hesperitin dihydrochalcone, or any combination thereof. The fatty acid compound may be used in combination with such other sweetness enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1. In some embodiments of any of the preceding embodiments, the fatty acid compound is combined with glucosylated steviol glycosides in any of the above ratios. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1,6 bond, a β-1,2 bond, a β-1,4 bond, a β-1,6 bond, and so forth.

In some further embodiments, ingestible compositions disclosed herein comprise the fatty acid compound combined with one or more umami or kokumi enhancing compounds. Such umami enhancing compounds include, but are not limited to, naturally derived compounds, such as (E)-3-(3,4-dimethoxyphenyl)-N-(4-methoxyphenethyl)-acrylamide, or synthetic compounds, such as N-(heptan-4-yl)-benzo[d][1,3]dioxole-5-carboxamide, N¹-(2,4-dimethoxybenzyl)-N²-(2-(pyridin-2-yl)ethyl)-oxalamide, alkyl amides, or any other compounds set forth in U.S. Pat. Nos. 8,735,081; 8,124,121; and 8,968,708. The fatty acid compound may be used in combination with such umami enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise the fatty acid compound combined with one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. The fatty acid compound may be used in combination with such umami enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1. In some embodiments, the comestible composition comprises: N-ethyl-N-(thiophen-2-ylmethyl)-2-(p-tolyloxy)acetamide; N-(1H-pyrazol-3-yl)-N-(thiophen-2-ylmethyl)-2-(p-tolyloxy)acetamide; 2-(4-fluorophenoxy)-N-(1H-pyrazol-3-yl)-N-(thiophen-2-ylmethyl)acetamide; 2-(2-hydroxy-4-methylphenoxy)-N-(1H-pyrazol-3-yl)-N-(thiophen-2-ylmethyl)-acetamide; 2-((2,3-dihydro-1H-inden-5-yl)oxy)-N-(1H-pyrazol-3-yl)-N-(thiophen-2-ylmethyl)-acetamide; 2-((2,3-dihydro-1H-inden-5-yl)oxy)-N-(1H-pyrazol-3-yl)-N-(thiazol-5-ylmethyl)-acetamide; 2-((5-methoxybenzofuran-2-yl)oxy)-N-(1H-pyrazol-3-yl)-N-(thiophen-2-ylmethyl)-acetamide, or any combination thereof in any of the aforementioned ratios. In some embodiments, such comestible compositions comprise menthol or a menthol analogue. In some further embodiments, such comestible compositions are compositions for use in oral care products, such as toothpaste, mouthwash, whitening compositions, dentifrices, and the like.

In some further embodiments, ingestible compositions disclosed herein comprise the fatty acid compound combined with one or more other bitterness blocking compounds. Such bitterness blocking compounds include, but are not limited to 3-(1-((3,5-dimethylisoxazol-4-yl)methyl)-1H-pyrazol-4-yl)-1-(3-hydroxybenzyl)-imidazolidine-2,4-dione, N-(7-acetyl-2,3-dihydrobenzo-[b][1,4]dioxin-6-yl)-2-(4-acetylpiperazin-1-yl)acetamide, or other compounds set forth in U.S. Pat. Nos. 8,076,491; 8,445,692; and 9,247,759, or in PCT Publication No. WO 2020/033669. The fatty acid compound may be used in combination with such bitterness blockers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise the fatty acid compound combined with one or more sour taste modulating compounds. The fatty acid compound may be used in combination with such sour taste modulating compounds in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise the fatty acid compound combined with one or more mouthfeel modifying compounds. Such mouthfeel modifying compounds include, but are not limited to, tannins, cellulosic materials, bamboo powder, and the like. The fatty acid compound may be used in combination with such mouthfeel enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise the fatty acid compound combined with one or more flavor masking compounds. Such flavor masking compounds include, but are not limited to, cellulosic materials, materials extracted from fungus, materials extracted from plants, citric acid, carbonic acid (or carbonates), and the like. The fatty acid compound may be used in combination with such mouthfeel enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In one embodiment, the ingestible composition comprises i) the fatty acid compound; ii) a carrier; and iii) optionally at least one adjuvant. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In some embodiments, the ingestible composition is encapsulated, for example, encapsulated in cellulosic- or starch-based microcapsules.

### Flavored Products

In certain aspects, the disclosure provides flavored products comprising any ingestible compositions of the preceding aspects. In some embodiments, the flavored products are beverage products, such as soda, flavored water, tea, and the like. In some other embodiments, the flavored products are food products, such as a dairy analogue product or a meat analogue product. In some other embodiments, the flavored product is an oral care product, such as toothpaste, mouthwash, whitening formulations, and the like. In some other embodiments, the flavored product is a nutraceutical product or a pharmaceutical product.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In certain embodiments of any aspects and embodiments set forth herein that refer to a flavored product, the flavored product is a non-naturally-occurring product, such as a packaged food or beverage product.

Further non-limiting examples of food and beverage products or formulations include sweet coatings, frostings, or glazes for such products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates: fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category generally refers to any food that can be a light informal meal including, but not limited to Sweet and savory snacks and snack bars. Examples of snack food include, but are not limited to fruit snacks, chips/crisps, extruded snacks, tortilla/coin chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionery category generally refers to edible product that is sweet to the taste. Examples of confectionery include, but are not limited to candies, gelatins, chocolate confectionery, sugar confectionery, gum, and the likes and any combination products.

The Meal Replacement category generally refers to any food intended to replace the normal meals, particularly for people having health or fitness concerns. Examples of meal replacement include, but are not limited to slimming products and convalescence products.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible product produced from mammal's milk. Examples of dairy product include, but are not limited to drinking milk products, cheese, yoghurt and sour milk drinks, and other dairy products.

Additional examples for flavored products, particularly food and beverage products or formulations, are provided as follows. Exemplary ingestible compositions include one or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary ingestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads or a mixture thereof. Exemplary ingestible compositions also include breakfast cereals, sweet beverages or solid or liquid concentrate compositions for preparing beverages, ideally so as to enable the reduction in concentration of previously known saccharide sweeteners, or artificial sweeteners.

Some embodiments provide a chewable composition that may or may not be intended to be swallowed. In some embodiments, the chewable composition may be gum, chewing gum, sugarized gum, sugar-free gum, functional gum, bubble gum including compounds as disclosed and described herein, individually or in combination.

In one embodiment, the flavored product can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavored product may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavored product is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

In some embodiments, the flavored product may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

In some embodiments, the flavored product includes a bulking agent. Suitable bulking agents include, but are not limited to maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, granulated sugar (sucrose) or other caloric sweeteners such as crystalline fructose, other carbohydrates, or sugar alcohols can be used as a bulking agent due to their provision of good content uniformity without the addition of significant calories.

In one embodiment, the bulking agent may be a bulking agent described in U.S. Pat. No. 8,993,027. In one embodiment, the bulking agent may be a bulking agent described in U.S. Pat. No. 6,607,771. In one embodiment, the bulking agent may be a bulking agent described in U.S. Pat. No. 6,932,982.

In some embodiments, the flavored product on may further comprise at least one anti-caking agent. As used herein the phrase “anti-caking agent” and “flow agent” refer to any composition which prevents, reduces, inhibits, or suppresses the at least one sweetener from attaching, binding, or contacting to another sweetener molecule. Alternatively, anti-caking agent may refer to any composition which assists in content uniformity and uniform dissolution. Non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

### Non-Animal Protein Materials and Products Made Therefrom

Products intended to replace or substitute meat or dairy products often rely on various non-animal-based materials, such as starches and proteins derived from plants, algae, fungi, or combinations thereof, to simulate the texture and flavor of meat or dairy. Non-limiting examples of non-animal-based proteins are plant proteins, such as soy proteins, pea proteins, bean proteins, grain proteins, and the like. Due to compositional differences between such plant-based materials and animal-derived materials, these proteins can impart a bitter taste.

Thus, in certain aspects, the disclosure provides a flavored product comprising a plant-based material (such as a plant-based starch, a plant-based protein, or a combination thereof) and the fatty acid compound. In some embodiments, the flavored product comprises the fatty acid compound, and a plant protein, such as pea protein, soy protein, potato protein, chickpea protein, bean proteins, or any combination thereof. In some further embodiments, the flavored product can include any features of combination of features set forth above for ingestible compositions that contain the fatty acid compound. In some embodiments, the flavored product is a beverage, such as soy milk, almond milk, rice milk, oat milk, a protein drink, a meal-replacement drink, or other like product. In some other embodiments, the flavored product is a meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation and/or manufacture of such products. For example, such the fatty acid compound may be combined with other flavors and taste modifiers, and may even be encapsulated in certain materials, according to known technologies in the relevant art. Suitable concentrations of the fatty acid compound are set forth above.

In some embodiments, the flavored products comprise one or more plant-based proteins, which impart a bitter taste that is at least partially reduced by the use of the fatty acid compound in the product. Such plant-based proteins include, but are not limited to, pea protein, soy protein, canola (rapeseed) protein, potato protein, chickpea protein, mycoproteins, algal proteins, fava protein, sunflower protein, wheat protein, and the like.

In some alternative embodiments analogous to the above embodiments, algal or fungal proteins or starches are used instead, oat protein, potato protein, and the like. In some embodiments, these flavored products also include fiber to provide texture to the product. Fibers suitable for use include, but are not limited to, psyllium fiber, pea fiber, potato fiber, curdlan, soluble corn fiber (dextran and/or maltodextrin), citrus fiber, and combinations thereof. In such products, the fatty acid compound can be introduced in any suitable way. In some embodiments, the fatty acid compound is incorporated into a flavoring emulsion, such as a water-in-oil emulsion, along with other flavor-imparting ingredients.

### Blocking Bitterness in Pharmaceutical APIs and Nutraceuticals

Many drug compounds impart a bitter taste, which therefore limits the ways in which they can be formulated and administered. Therefore, in certain aspects, the disclosure provides a nutraceutical or pharmaceutical composition comprising a bitter-tasting nutraceutical or pharmaceutical active ingredient, and the fatty acid compound. Such nutraceutical or pharmaceutical compositions can be in any suitable form for oral administration, such as tablets, lozenges, capsules, powders, liquid solutions, liquid suspensions, and the like. Such nutraceutical or pharmaceutical compositions can include any suitable excipients, binders, and the like, such as those set forth in Remington's Pharmaceutical Sciences. In some embodiments, the bitter-tasting pharmaceutical active ingredient is an ion channel inhibitor, such as a proton channel inhibitor. Other examples of bitter-tasting APIs whose bitterness is reduced by the fatty acid compound, include, but are not limited to, acetaminophen, atropine, brinzolamide, chloramphenicol, chloroquine, clindamycin, dexamethasone, digoxin, diltiazem, diphenhydramine, docusate, dorzolamide, doxepin, doxylamine, enalapril, erythromycin, esomeprazole, famotidine, gabapentin, ginkgolide A, guaifenesin, L-histidine, lomefloxacin, methylprednisolone, ofloxacin, oleuropein, oxyphenonium, pirenzepine, prednisone, ranitidine, trapidil, trimethoprim, and cetirizine.

### Use in Oral Care Products

Oral care products often contain ingredients that impart astringent or bitter off tastes. Such ingredients include menthol, menthol analogues, mint extracts, sodium bicarbonate, alkali metal salts of peroxymonosulfate (potassium peroxymonosulfate), cetylpyridinium chloride, lauramidopropyl betaine, cocamidopropyl betaine, arginine, hydrogen peroxide, chlorhexidine gluconate, zinc phosphate, zinc chloride, zinc citrate, potassium nitrate, pentasodium triphosphate, tetrasodium pyrophosphate, stannous fluoride, thymol, methyl salicylate, eucalyptol, or any combination thereof. Suitable oral care products include toothpaste, mouthwashes, whitening agents, dentifrices, and the like. In certain aspects, the disclosure provides oral care products that comprise a fatty acid compound, as set forth herein.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

### Example 1—Oat/Pea Protein Blend at 3% with Fatty Acid at 400 ppm

Liquid solutions of a blend of oat and pea protein (1:14 w/w) were prepared (about 3 percent by weight in water) without sugar added. Control and test samples were prepared. To the test sample 10-undecenoic acid was added at a concentration of 400 ppm. The control and test samples were evaluated by eight sensory panelists to rate various characteristics of the control sample and the test sample on a scale from 0 to 5. A higher score indicates that the characteristic is more intense in the sample. Table 3 shows the mean results for control sample and the two test samples.

TABLE 3

| | Control | Test |
|---|---|---|
| Sweet | 2.9 | 3.6 |
| Bitter | 2.5 | 1.7 |
| Astringent | 2.3 | 1.8 |
| Mouthcoating | 1.9 | 2.0 |
| Thickness | 1.8 | 1.9 |
| Fattiness | 1.8 | 1.4 |
| Green/Vegetal Note | 2.3 | 2.1 |
| Cereal Note | 2.7 | 2.5 |
| Creaminess | 1.6 | 1.6 |

### Example 2—Oat/Pea Protein Blend at 6% with Fatty Acid at 400 ppm

Liquid solutions of a blend of oat and pea protein (1:28 w/w) were prepared (about 6 percent by weight in water) without sugar added. Control and test samples were prepared. To the test sample 10-undecenoic acid was added at a concentration of 400 ppm. The control and test samples were evaluated by eight sensory panelists to rate various characteristics of the control sample and the test sample on a scale from 0 to 5. A higher score indicates that the characteristic is more intense in the sample. Table 4 shows the mean results for control sample and the two test samples.

TABLE 4

| | Control | Test |
|---|---|---|
| Sweet | 2.6 | 3.1 |
| Bitter | 2.6 | 1.8 |
| Astringent | 3.0 | 1.8 |
| Mouthcoating | 2.8 | 3.3 |
| Thickness | 2.5 | 2.9 |
| Fattiness | 2.8 | 2.3 |
| Green/Vegetal Note | 3.2 | 2.3 |
| Cereal Note | 3.0 | 2.8 |
| Creaminess | 2.1 | 2.4 |

### Example 3—Pea Protein Blend at 3% with Fatty Acid at 700 ppm

Liquid solutions of pea protein were prepared (3 percent by weight in water) without sugar added. Control and test samples were prepared. To the test sample 10-undecenoic acid was added at a concentration of 700 ppm. The control and test samples were evaluated by eight sensory panelists to rate various characteristics of the control sample and the test sample on a scale from 0 to 5. A higher score indicates that the characteristic is more intense in the sample. Table 5 shows the mean results for control sample and the two test samples.

TABLE 5

| | Control | Test |
|---|---|---|
| Sweet | 2.6 | 3.1 |
| Bitter | 3.1 | 2.1 |
| Astringent | 3.3 | 2.6 |
| Mouthcoating | 1.9 | 2.3 |
| Thickness | 1.7 | 2.0 |
| Fattiness | 1.6 | 1.9 |
| Green/Vegetal Note | 3.1 | 2.4 |
| Cereal Note | 3.0 | 2.4 |
| Creaminess | 1.4 | 1.8 |

### Example 4—Pea Protein Blend at 3% with Fatty Acid at 1000 ppm

Liquid solutions of pea protein were prepared (3 percent by weight in water) without sugar added. Control and test samples were prepared. To the test sample 10-undecenoic acid was added at a concentration of 1000 ppm. The control and test samples were evaluated by eight sensory panelists to rate various characteristics of the control sample and the test sample on a scale from 0 to 5. A higher score indicates that the characteristic is more intense in the sample. Table 6 shows the mean results for control sample and the two test samples.

TABLE 6

| | Control | Test |
|---|---|---|
| Sweet | 2.9 | 3.4 |
| Bitter | 2.6 | 1.7 |
| Astringent | 2.8 | 2.1 |
| Mouthcoating | 2.1 | 2.9 |
| Thickness | 1.6 | 2.1 |
| Fattiness | 2.0 | 2.0 |
| Green/Vegetal Note | 2.8 | 2.0 |
| Cereal Note | 2.8 | 2.7 |
| Creaminess | 1.4 | 2.1 |

### Example 5—Chickpea Protein Blend at 6% with Fatty Acid at 700 ppm

Liquid solutions of xchickpea protein were prepared (6 percent by weight in water) without sugar added. Control and test samples were prepared. To the test sample 10-undecenoic acid was added at a concentration of 700 ppm. The control and test samples were evaluated by 18 sensory panelists to rate various characteristics of the control sample and the test sample on a scale from 0 to 5. A higher score indicates that the characteristic is more intense in the sample. Table 7 shows the mean results for control sample and the two test samples.

TABLE 7

| | Control | Test |
|---|---|---|
| Sweet | 2.5 | 2.8 |
| Bitter | 2.7 | 2.1 |
| Astringent | 3.0 | 2.4 |
| Mouthcoating | 2.1 | 2.4 |
| Thickness | 1.6 | 1.6 |
| Fattiness | 2.0 | 1.9 |
| Green/Vegetal Note | 3.0 | 2.8 |
| Cereal Note | 2.9 | 2.7 |
| Creaminess | 1.5 | 2.3 |

### Example 6—Fava Bean Protein Blend at 6% with Fatty Acid at 400 ppm

Liquid solutions of fava bean protein were prepared (6 percent by weight in water) without sugar added. Control and test samples were prepared. To the test sample 10-undecenoic acid was added at a concentration of 400 ppm. The control and test samples were evaluated by 18 sensory panelists to rate various characteristics of the control sample and the test sample on a scale from 0 to 5. A higher score indicates that the characteristic is more intense in the sample. Table 8 shows the mean results for control sample and the two test samples.

TABLE 8

| | Control | Test |
|---|---|---|
| Sweet | 1.9 | 2.3 |
| Bitter | 3.8 | 2.4 |
| Astringent | 3.9 | 3.2 |
| Mouthcoating | 1.3 | 1.8 |
| Thickness | 1.1 | 1.2 |
| Fattiness | 1.2 | 1.3 |
| Green/Vegetal Note | 3.5 | 2.7 |
| Cereal Note | 2.3 | 2.3 |
| Creaminess | 0.8 | 1.2 |

1. Use of a fatty acid compound for modifying a flavor of an ingestible composition, wherein the ingestible composition comprises a non-animal protein, and wherein the fatty acid compound is a compound of formula (I) or a comestibly acceptable salt thereof: 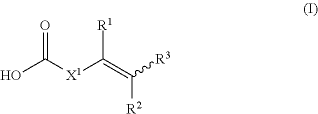
wherein:
R¹ and R² are each independently a hydrogen atom or C₁₋₄ alkyl;
R³ is a hydrogen atom, C₁₋₂₀ alkyl, or C₂₋₂₀ alkenyl; and
X¹ is a direct bond or C₁₋₁₆ alkylene; or
a compound of formula (II) or a comestibly acceptable salt thereof: 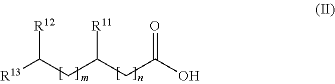
wherein:
R¹¹, R¹², and R¹³ are each independently a hydrogen atom or C₁₋₄ alkyl;
m is an integer ranging from 1 to 12;
n is an integer ranging from 0 to 12; and
wherein m+n is no more than 14.

2. The use of claim 1, wherein the fatty acid compound is a compound of formula (I).

3. The use of claim 2, wherein R¹, R², and R³ are all a hydrogen atom and X¹ is C₁₋₁₆ alkylene.

3. The use of claim 3, wherein the fatty acid compound is 10-undecenoic acid.

4. The use of any one of claims 1 to 3, wherein the non-animal protein is a plant protein, a mycoprotein, an algal protein, or any combination thereof.

5. The use of claim 4, wherein the non-animal protein is a plant protein, such as pea protein, soy protein, almond protein, cashew protein, canola (rapeseed) protein, chickpea protein, fava bean protein, sunflower protein, mung bean protein, red lentil protein, wheat protein, oat protein, potato protein, or any combinations thereof.

6. The use of any one of claims 1 to 5, wherein modifying a flavor comprises enhancing a sweet taste, reducing a bitter taste, reducing an astringent taste, enhancing mouthcoating, enhancing thickness, reducing a green vegetal taste, reducing a cereal taste, enhancing a creamy taste, or any combination thereof.

7. The use of claim 6, wherein modifying a flavor comprises reducing a bitter taste, reducing an astringent taste, or a combination thereof.

8. The use of any one of claims 1 to 7, wherein the fatty acid compound is used at a concentration ranging from 100 ppm to 2000 ppm, based on the total weight of the ingestible composition.

9. A method of modifying a flavor of an ingestible composition, the method comprising introducing a fatty acid compound to the ingestible composition, wherein the ingestible composition comprises a non-animal protein, and wherein the fatty acid compound is a compound of formula (I) or a comestibly acceptable salt thereof: 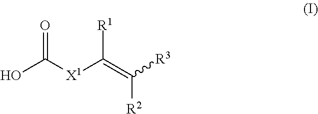
wherein:
R¹ and R² are each independently a hydrogen atom or C₁₋₄ alkyl;
R³ is a hydrogen atom, C₁₋₂₀ alkyl, or C₂₋₂₀ alkenyl; and
X¹ is a direct bond or C₁₋₁₆ alkylene; or
a compound of formula (II) or a comestibly acceptable salt thereof: 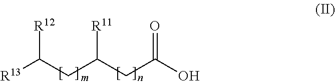
wherein:
R¹¹, R¹², and R¹³ are each independently a hydrogen atom or C₁₋₄ alkyl;
m is an integer ranging from 1 to 12;
n is an integer ranging from 0 to 12; and
wherein m+n is no more than 14.

10. The method of claim 9, wherein modifying a flavor comprises enhancing a sweet taste, reducing a bitter taste, reducing an astringent taste, enhancing mouthcoating, enhancing thickness, reducing a green vegetal taste, reducing a cereal taste, enhancing a creamy taste, or any combination thereof.

11. The method of claim 10, wherein modifying a flavor comprises reducing a bitter taste, reducing an astringent taste, or a combination thereof.

12. An ingestible composition, which comprises a non-animal protein and a fatty acid compound, wherein the fatty acid compound is a compound of formula (I) or a comestibly acceptable salt thereof: 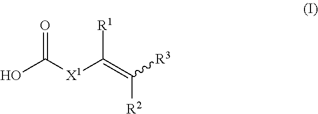
wherein:
R¹ and R² are each independently a hydrogen atom or C₁₋₄ alkyl;
R³ is a hydrogen atom, C₁₋₂₀ alkyl, or C₂₋₂₀ alkenyl; and
X¹ is a direct bond or C₁₋₁₆ alkylene; or
a compound of formula (II) or a comestibly acceptable salt thereof: 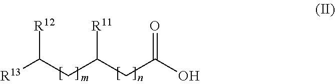
wherein:
R¹¹, R¹², and R¹³ are each independently a hydrogen atom or C₁₋₄ alkyl;
m is an integer ranging from 1 to 12;
n is an integer ranging from 0 to 12; and
wherein m+n is no more than 14.

13. A flavored product, which comprises an ingestible composition of claim 12.

14. The flavored product of claim 13, wherein the flavored product is a meat analogue product or a dairy analogue product, and wherein the ingestible composition comprises a non-animal protein selected from the group consisting of a plant protein, a mycoprotein, an algal protein, or any combination thereof.
